(19) United States
(12) Patent Application Publication
(10) Pub. No.: US 2026/0241467 A1
(43) Pub. Date: Aug. 20, 2026

(54) POSITIVE CUTTING INSERT

(71) Applicant: KENNAMETAL INC., Latrobe, PA (US)

(72) Inventors: Fabian Birkmann, Fuerth (DE); Igor Kaufmann, Fuerth (DE)

(21) Appl. No.: 19/540,319

(22) Filed: Feb. 13, 2026

(30) Foreign Application Priority Data
Feb. 20, 2025 (DE) 1020251064865

(51) Int. Cl. B23C 5/20; B23C 5/22

(52) U.S. Cl. CPC B23C 5/202; B23C 5/2213

(57) ABSTRACT

The invention relates to a positive cutting insert (10) having a chip face (14), a primary free surface (24), and a secondary free surface (26), wherein a cutting edge (12) is formed between the chip face (14) and the primary free surface (24), characterized in that the secondary free surface (26) is offset relative to the primary free surface (24) towards the interior of the cutting insert (10) and is bounded in a direction parallel to the cutting edge on each side.

### RELATED APPLICATION DATA

The present application claims priority pursuant to 35 U.S.C. § 119(a) to German Patent Application No. 1020251064865, filed Feb. 20, 2025, which is incorporated herein by reference in its entirety.

### FIELD

The invention relates to a positive cutting insert having a chip face, a primary free surface, and a secondary free surface, wherein a cutting edge is formed between the chip face and the primary free surface.

### BACKGROUND

Cutting inserts are essential components in machining technology. They are used in tools such as rotary bits, milling tools, and drills and allow for efficient removal of material from workpieces. Most often, they are indexable so as to be able to utilize a new, unworn cutting edge with little effort when a cutting edge is worn. Due to the cutting angle of positive cutting inserts, there are low cutting forces as well as a high surface quality of the machined workpiece.

The production of cutting inserts is usually carried out by powder metallurgy. A powdered carbide mixture is filled into a mold and pressed under high pressures to produce a so-called “preform”. Then, this preform is heated in a sintering process, whereby the powder particles fuse together and the cutting insert obtains its final strength and hardness.

A key challenge in powder metallurgical manufacturing is to achieve as homogeneous a density as possible in the final pressed preform. Density differences in the preform lead to inhomogeneous shrinkage during sintering, which in turn can cause warpage, cracking, or dimensional deviations in the finished cutting insert.

It has been found that, especially with positive cutting inserts, the problem often arises that the powdered material in the region of the cutting edge is less compressed during the pressing operation than in other regions. This is due to the geometry of the bit shape and the different cross sections along the cutting insert. The lower compression results in a lower density of the preform in the region of the cutting edge.

During subsequent sintering, lower density regions shrink more than densely compressed regions. This results in uneven shrinkage of the cutting insert, thereby compromising the precise geometry of the cutting edge. The result is cutting inserts with dimensional deviations, higher cutting forces, and correspondingly higher heat load and consequently a lower service life.

### SUMMARY

The object of the invention is to create a positive cutting insert that is characterized by particularly high dimension conformity.

The present invention provides an effective solution to the problem described through a specific design of the free surface of the cutting insert. Generally speaking, the sections of the free surface that are removed from the cutting edge are further inward than the sections that are closer to the cutting edge. Specifically, in a positive cutting insert of the above-mentioned type, the secondary free surface is provided to be offset relative to the primary free surface towards the interior of the cutting insert and is limited in a direction parallel to the cutting edge on each side.

This geometrical adjustment causes the powdered material to be compressed more evenly throughout the pressing process. In particular, it is more compressed in the cutting region in order to achieve an even density. By retracting the regions further away from the cutting edge, the cross section of the cutting insert is reduced at these locations. This results in the pressing force being transferred more efficiently to the total powder volume, in particular to the critical regions at the cutting edge. The result is more homogeneous compression of the powder throughout the cutting insert. The limitation of the secondary free surface results in concretely delineated regions in which the higher pressing force can be concentrated.

During sintering, the uniform packing density results in a uniform shrinkage behavior. The geometrical integrity of the cutting edge is maintained and dimensional deviations are significantly reduced. This increases the precision and quality of the produced cutting inserts and improves their performance and service life in practical use.

In addition, this solution allows for an optimization of the manufacturing process without significant modifications to the existing pressing tools or sintering furnaces. The improved free surface geometry can be implemented with minimal effort and reduces the reject rate.

In an embodiment of the invention, the secondary free surface extends continuously from a first corner free surface to a second corner free surface. The technical advantage of this continuous secondary free surface is the improved structural integrity of the cutting insert. The continuous surface allows for an even distribution of mechanical stresses along the secondary free surface, thereby avoiding localized stress peaks. This leads to increased stability and service life of the cutting insert, as fracture points are reduced and the resilience to mechanical impacts is increased.

In this case, the secondary free surface can be designed flat so that it can be manufactured with little effort and high precision. Further, the pressing forces are evenly distributed along the secondary free surface in the production of the preform resulting in improved dimension conformity of the sintered cutting insert.

In an alternative embodiment, the secondary free surface is wavy, uneven, or concave when viewed along the associated cutting edge. The wavy secondary free surface results in increased mechanical stability of the cutting insert. The wave-like structure may better absorb and distribute the cutting forces, increasing overall strength. In addition, a larger surface area results so that the wave-like structure can better dissipate the heat generated during machining, similar to cooling ribs.

In a further embodiment, a plurality of secondary open surfaces are provided along one side of the cutting insert between a first and a second corner free surface. The technical advantage of this design having a plurality of secondary open surfaces is that they increase the structural strength of the cutting insert. By dividing the secondary free surface, stresses can be more specifically dissipated and material weakening can be avoided. This leads to improved service life and higher reliability of the cutting insert in continuous use.

The secondary free surfaces may be embodied as grooves between which an extension of the primary free surface extends. The ribs between the grooves, which are an extension of the primary free surface, function as reinforcing structures that improve the stiffness of the cutting insert, stabilize the cutting edge, and dissipate the cutting forces acting on the cutting edge well.

In one embodiment, it is provided that the grooves taper off towards a base side of the cutting insert so that the base side (i.e., the support surface) has a straight outer edge. The advantage of this embodiment is that the linear outer edge allows for exact positioning and fastening of the cutting insert in the toolholder. The tapering of the grooves towards the base side prevents stress concentrations at the edges and reduces the risk of material weakening. This improves the durability of the cutting insert and ensures stable mounting. Furthermore, a large base side results, reducing the surface compression.

The grooves may have a constant width so that mechanical stresses are evenly distributed along the secondary free surface. A uniform groove geometry also simplifies manufacturing and ensures consistent quality of the cutting insert.

In one embodiment, the cutting insert has a fastening opening extending through a base side and through the chip face. Such a cutting insert can be easily and securely mounted, particularly in already existing receiving pockets, by means of a fastening screw extending through the fastening opening.

The cutting insert may have a polygonal shape, so that multiple mounting positions are possible, wherein a new, unworn cutting edge is quickly available upon wear. In the case of a rectangular cutting insert, four possible mounting positions result. Other examples include T-plates and W-plates.

According to one embodiment of the invention, the cutting insert has a circular shape with a fastening opening extending through the base surface and through the chip face. Compression of the powder during pressing also has an advantageous effect on cutting inserts with a round cutting edge.

As an alternative to a fastening opening, the cutting insert can be arranged such that it can be clamped from above with a clamping claw or similar on a toolholder.

According to one embodiment, the chip face adjacent to the cutting edge is designed to be concave, which allows the powder to be compressed particularly well and evenly when the preform is pressed in cooperation with the retracted secondary free surface. In addition, the known advantages of a concave chip face may be utilized.

Alternatively, the chip face may also be negative or flat.

The invention is described below based on various embodiments which are shown in the enclosed drawings.

### DESCRIPTION OF THE DRAWINGS

The figures show:

FIG. 1 illustrates a cutting insert according to the prior art;

FIG. 2. Illustrates in a perspective view, a cutting insert according to a first embodiment of the invention,

FIG. 3 illustrates in a schematic cross-sectional view, the cutting insert when rotating according to the first embodiment;

FIG. 4 illustrates a cutting insert according to a second embodiment in a side view;

FIG. 5 illustrates the cutting insert of FIG. 4 in a plan view,

FIG. 6 illustrates the cutting insert of FIG. 4 in a perspective view,

FIG. 7 illustrates the cutting insert of FIG. 4 in a bottom view;

FIG. 8 illustrates the cutting insert of FIG. 4 in a cross section along plane VIII-VIII of FIG. 9;

FIG. 9 illustrates a view corresponding to that of FIG. 4 supplemented by dimensional information;

FIG. 10 illustrates a cutting insert according to a third embodiment in a side view;

FIG. 11 illustrates the cutting insert of FIG. 10 in a plan view;

FIG. 12 illustrates the cutting insert of FIG. 10 in a perspective view;

FIG. 13 illustrates the cutting insert of FIG. 10 in a bottom view;

FIG. 14 illustrates the cutting insert of FIG. 10 in a section along the plane XIV-XIV of FIG. 15; and

FIG. 15 illustrates a view corresponding to that of FIG. 10 supplemented by dimensional information;

FIG. 16 shows a cutting insert according to a fourth embodiment in a side view;

FIG. 17 shows a plan view of the cutting insert of FIG. 16;

FIG. 18 shows a perspective view of the cutting insert of FIG. 16;

FIG. 19 shows a bottom view of the cutting insert of FIG. 16;

FIG. 20 shows another side view of the cutting insert of FIG. 16 supplemented by a cut plane;

FIG. 21 shows a cross section through the cutting insert of FIG. 16 along plane XXI-XXI of FIG. 20;

FIG. 22 shows a cutting insert according to a fifth embodiment in a side view;

FIG. 23 shows a plan view of the cutting insert of FIG. 22;

FIG. 24 shows a perspective view of the cutting insert of FIG. 22;

FIG. 25 shows a bottom view of the cutting insert of FIG. 22;

FIG. 26 shows a side view of the cutting insert of FIG. 22, supplemented by a cut plane; and

FIG. 27 shows a cut through the cutting insert of FIG. 22 along the plane XXVII-XXVII of FIG. 26. In FIG. 1, a positive cutting insert 10 according to the prior art can be seen. It has four cutting edges 12 formed at the transition between a chip face 14 and four free surfaces 16.

### DETAILED DESCRIPTION

The cutting insert 10 is designed as a cube and has a fastening opening 18 extending from the chip face 14 through the body of the cutting insert 10 towards a base surface 20. With the base surface 20, the cutting insert 10 is stretched in a pocket of a toolholder.

The free surfaces 16 are designed to be flat here, with the base surface 20 having a smaller contour than the chip face 14. In other words, the cutting edges 12, in a plan view, overhang the base surface 20.

In FIG. 2, a first embodiment of a cutting insert 10 according to the invention is shown.

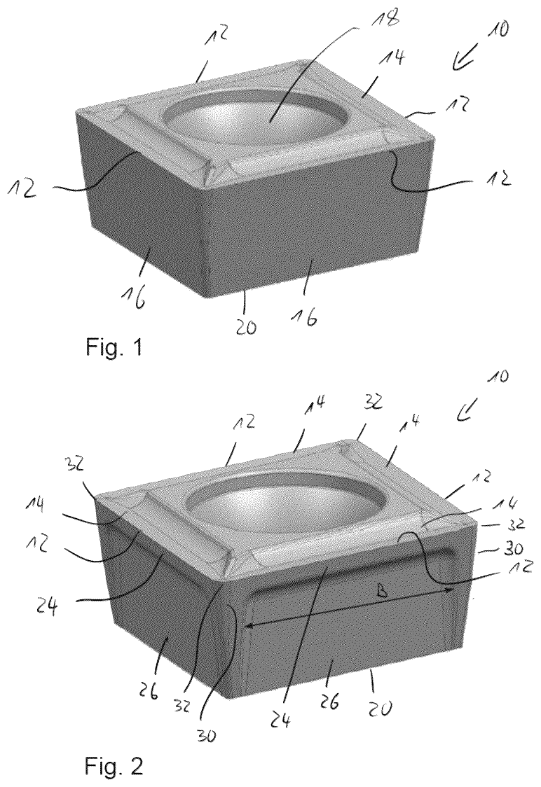

In the same manner as in the cutting insert 10 of FIG. 1, the cutting insert 10 of FIG. 2 is designed as a cube. It therefore has a square base surface 20, four side surfaces, and a chip face 14 on the top side of the cutting insert 10.

Alternatively, the cutting insert can also be generally rectangular, for example with a rhombic shape. Such a cutting insert may be used for penetration.

Further alternatives are triangular plates, T-plates, or W-plates.

The base surface 20 forms the base of the cutting insert 10 and serves as a support surface in the toolholder. The four side surfaces 22 extend from the base surface 20, which represent the free surfaces 16 of the cutting insert 10.

Each of the free surfaces 16 is divided into a primary free surface 24 and a secondary free surface 26.

The primary free surface 24 directly abuts the chip face 14. The transition from the primary free surface 24 to the chip face 14 forms the cutting edge 12 on which the workpiece is machined during the machining process. The primary free surface 24 is at a defined free angle to the plane defined by the base surface 20 to ensure optimal cutting conditions. Adjacent to the cutting edge 12, the chip face 14 is concave in configuration to obtain optimal chip flow.

Further geometric features may be provided on the chip face 14 to guide the chips formed during the machining in the desired manner.

Below the primary free surface 24, the secondary free surface 26 is arranged, which is retracted towards the interior of the cutting insert 10. This secondary free surface 26 is thus offset from the primary free surface 24, whereby the area “behind” the primary free surface 24 represents an overhang or “balcony” to the area “behind” the secondary free surface 26. In other words, the primary free surface 24 protrudes outwardly across the secondary free surface 26.

The width B of the secondary free surface 26 measured in the extension direction of the cutting edge 12 is a majority of the width of the cutting insert 10. In the exemplary embodiment shown, the ancillary cutting edge 28 extends to the corner free surfaces 30 that are present below the cutting corners 32. In other words, the secondary free surface 26 is bounded in a direction parallel to the cutting edge 12 on each side, here by the corner free surfaces 30.

The special design of the cutting insert 10 with the retracted secondary free surface 26 and the resulting overhang achieves uniform compression of the powdered material during the production of the preform. During the pressing operation, the pressing tool may act on both the chip face 14 and the base surface 20. In particular, the tool effectively impacts the powdered material in the region of the primary free surface 24.

The pressing forces exerted from top and bottom allow for even compression of the powdered material, particularly in the critical region of the primary free surface 24 and cutting edge 12. Due to the reduced material thickness in the region of the retracted secondary free surface 26, the pressing force is efficiently transferred to the entire cross-sectional profile. This leads to a homogeneous density distribution in the preform.

During the subsequent sintering process, the preform shrinks evenly as differences in density have been minimized. This results in a cutting insert 10 with high dimension conformity and a precisely pronounced cutting edge 12.

Due to the cubic shape, in this exemplary embodiment, the cutting insert 10 has four usable cutting edges 12. This increases economic efficiency and flexibility in the manufacturing process.

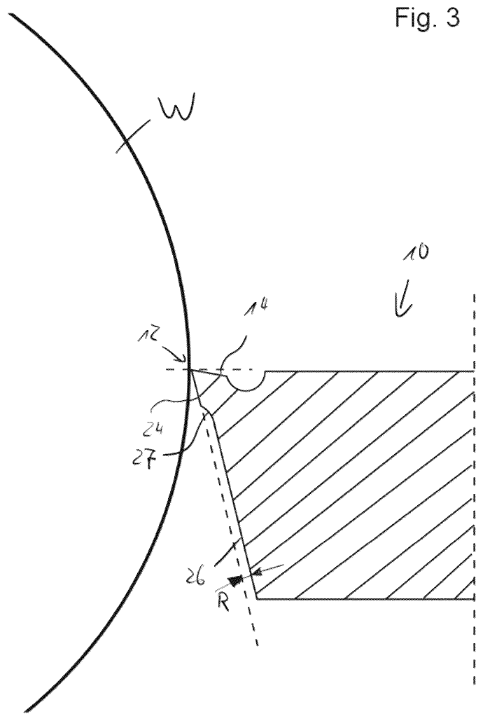

In FIG. 3, the cutting insert 10 of FIG. 2 can be seen in an application case when used in machining a workpiece by rotating. The toolholder for the cutting insert 10 is not shown here.

In FIG. 3, the balcony-like protruding area of the primary free surface 24, which results from the recess R of the secondary free surface 26 compared to the primary free surface 24, can be seen well. FIG. 3 also clearly shows that the powdered material can be well compressed from above and below when the preform is pressed, since a pressing tool can act on the transition surface 27 from the primary free surface 24 to the secondary free surface 26, while simultaneously pressing from above, i.e., the side of the chip face 14.

It should be noted here that the cutting insert according to the invention, even if it is shown here to illustrate an application case when turning, can in principle also be used for other cutting applications, in particular for milling.

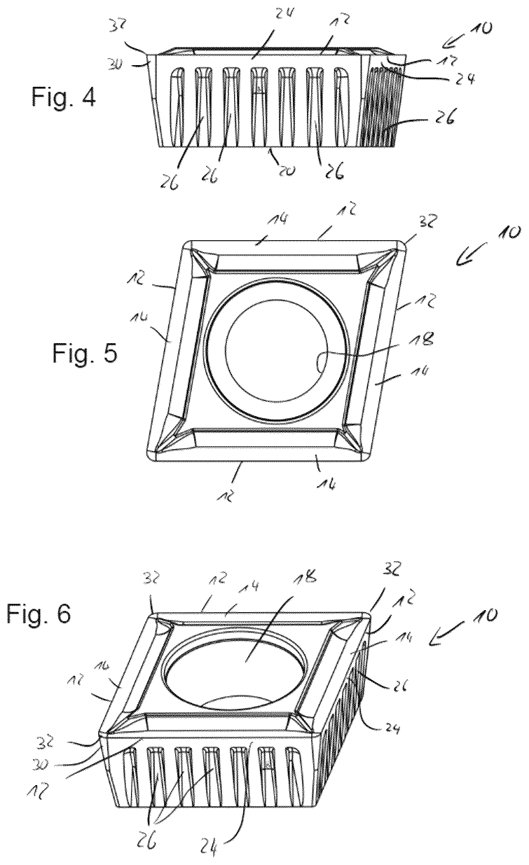

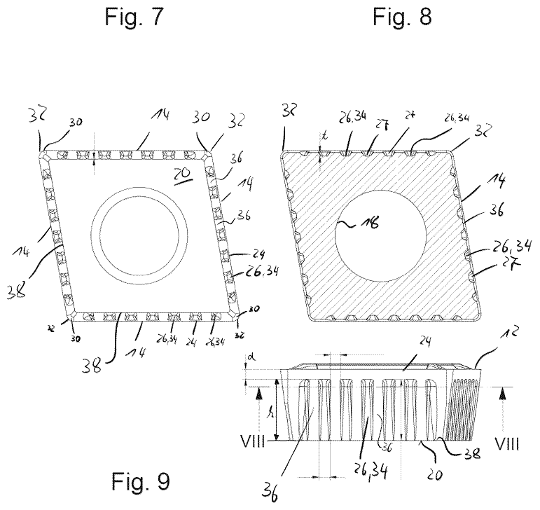

FIGS. 4 to 9 show a cutting insert 10 according to a second embodiment. The same reference signs are used for the features known from the first embodiment, and reference is made in this respect to the above explanations.

The difference between the first and the second embodiment is that in the second embodiment, the secondary free surface 26 is designed differently.

Unlike in the first embodiment, the secondary free surface 26 here does not run continuously from one corner free surface 30 to the other, but is embodied as a plurality of grooves 34 arranged adjacent to one another. These grooves 34 extend downwardly towards the base surface 20 from the level at which the primary free surface 24 ends in the first embodiment.

The now present ribs 36 between the plurality of secondary free surfaces 26 represent an extension of the primary free surface 24 and continue downwards from the primary free surface 24.

The grooves 34 are arranged here to taper off towards the base surface 20 of the cutting insert 10 such that the base surface 20 has a straight outer edge 38 on all four sides. This facilitates exact positioning and fastening of the cutting insert 10 in the toolholder.

The advantage of the second embodiment is that a good compromise is obtained between uniformly pressing the powdered material in the production of the preform and a high stability of the final cutting insert 10. The grooves 34 allow the pressing tool to apply pressing force in sections from below the “balcony” so that the region within the primary free surface 24 can be exposed to a high pressing force. The spacing of the grooves 34 is selected such that the pressing force is evenly distributed in the overhanging section of material. The ribs 36, i.e., the extensions of the primary free surface 24, act as a support for the “balcony”, i.e., the overhanging primary free surface 24.

The grooves 34 here begin with a distance d from the cutting edge 12, which may be in the order of magnitude of 0.1 mm to 1 mm. In the exemplary embodiment shown, the distance d is about 0.6 mm.

The depth t of the grooves 34 may be in the order of magnitude of 0.1 mm to 0.3 mm.

The distance of the grooves 34 to the corner radius 40 is in the order of magnitude of 0.1 mm to 1 mm.

The height h of the grooves 34 in the exemplary embodiment shown is around 3 mm.

The grooves 34 are herein embodied at a constant width, which simplifies production and ensures uniform mechanical loading along the secondary free surface 26.

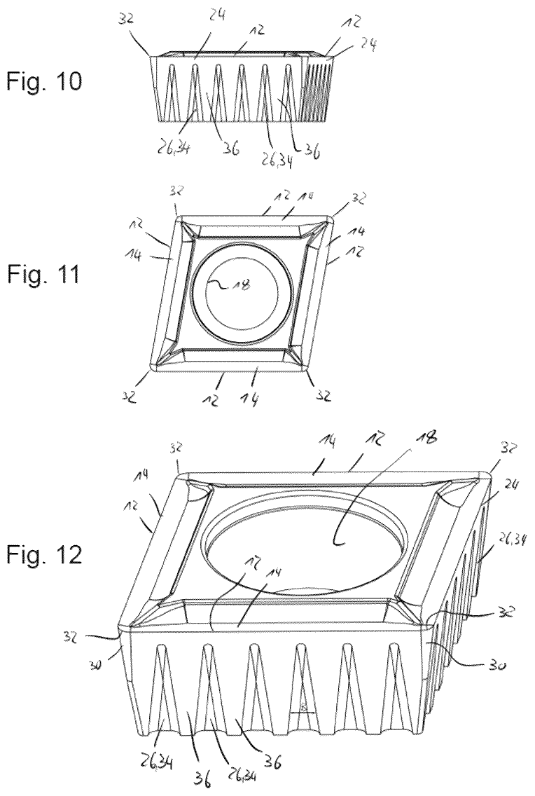

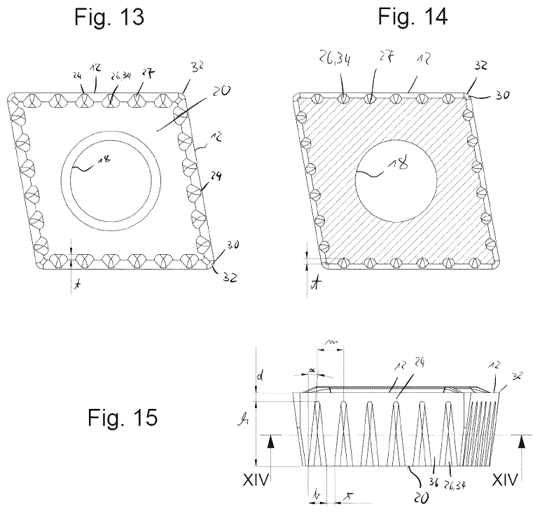

FIGS. 10 to 15 show a cutting insert 10 according to a third embodiment. The same reference signs are used for the features known from the second embodiment, and reference is made in this respect to the above explanations.

A difference between the second and the third embodiment is that in the third embodiment, the grooves 34 forming the retracted secondary free surface 26 do not have a constant width, but instead become wider towards the base surface 20.

Another difference between the second and the third embodiment is that in the third embodiment, the grooves 34 do not taper off towards the base surface 20 but are still visible at the level of the base surface 20, namely as concave portions of the outer edge 38 of the base surface 20.

The ribs 36 formed between the grooves 34 also represent a continuous extension of the primary free surface 24 subsequent to the cutting edge 12.

The grooves 34 here begin with a distance d from the cutting edge 12, which may be in the order of magnitude of 0.1 mm to 1 mm. In the exemplary embodiment shown, the distance d is about 0.5 mm.

The depth t of the grooves 34 may be in the order of magnitude of 0.1 mm to 0.3 mm. In the exemplary embodiment shown, the depth t is 0.3 mm.

The distance of the grooves 34 to the corner radius 40 is in the order of magnitude of 0.1 mm to 1 mm.

The height h of the grooves 34 in the exemplary embodiment shown is around 3.5 mm.

On the side of the chip face 14, the distance m between the centerlines of adjacent grooves 34 is about 1.4 mm. On the side of the base surface 20, the grooves 34 have a width b of about 1 mm, while the ribs 36 disposed therebetween have a width r of about 0.4 mm.

The half opening angle α of the truncated extending grooves 34 is 6° here.

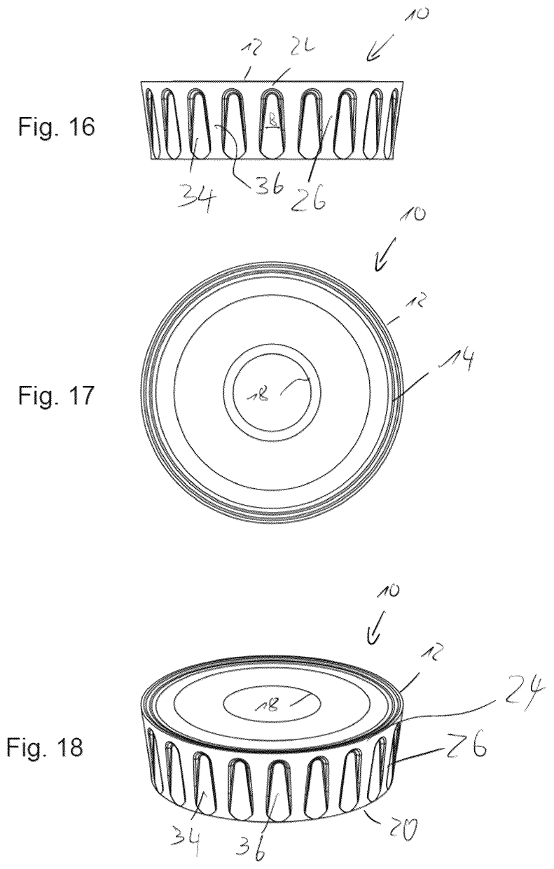

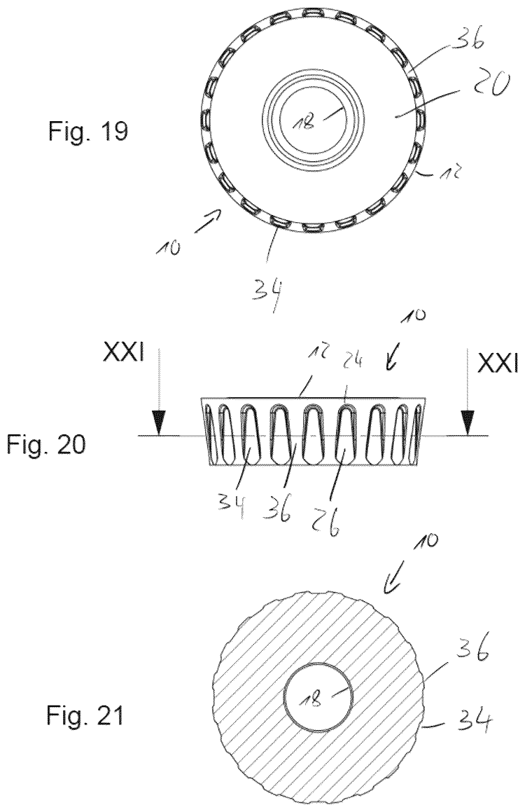

FIGS. 16 to 21 describe a cutting insert according to a fourth embodiment. For the features known from the previous embodiments, the same reference numerals are used, and reference is made in this respect to the above explanations.

The essential difference between the preceding embodiments and the fourth embodiment is that in the fourth embodiment, the base body has a round rather than angular configuration. Accordingly, the cutting edge 12 has a circular shape and the base surface 20 is also flat. The thus defined support surface is annular and serves to provide support on the bottom of a receiving pocket in the toolholder.

The chip face 14 is located on the top side of the cutting insert 10 and is designed according to the previous embodiments. Between the chip face 14 and the primary free surface 24 the cutting edge 12 used to machine the workpiece is formed. The primary free surface 24 extends downward from the cutting edge 12 and has the same clearance angle as in the previous embodiments.

The secondary free surface 26 is offset relative to the primary free surface 24 towards the interior of the cutting insert 10, thereby creating an overhang, similar to the angular embodiments. This configuration allows for even compression of the powdered material during production of the preform and results in high dimension conformity of the final cutting insert 10. The grooves 34 of this embodiment extend to the base surface 20 such that the outer edge of the base surface 20 is a closed circle.

The fastening opening 18 extends axially through the cutting insert 10 from the cutting surface 14 to the base surface 20 so that the cutting insert 10 can be securely fastened in the toolholder.

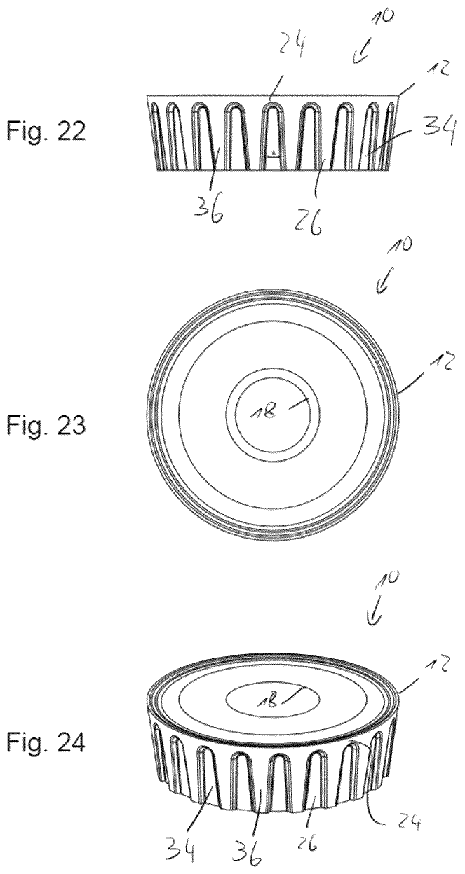

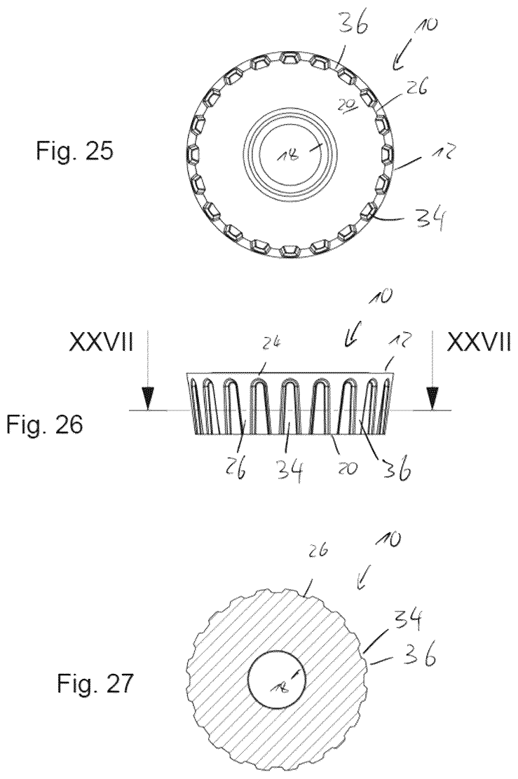

FIGS. 22 to 27 show a cutting insert 10 according to a fifth embodiment. For the features known from the previous embodiments, the same reference numerals are used, and reference is made in this respect to the above explanations.

Accordingly, the cutting insert 10 has a generally circular base surface 20 and a correspondingly designed chip face 14. The cutting edge 12 is formed between the chip face 14 and the primary free face 24, analogous to the previous embodiments.

Again, the secondary free surface 26 has a plurality of grooves 34 disposed along the perimeter that are evenly spaced. They extend from the primary free surface 24 down to the base surface 20. Between the grooves 34 are ribs 36 which represent an extension of the primary free surface 24 and contribute to the structural stability of the cutting insert 10.

The grooves 34 may have a constant width or may widen toward the base surface 20.

The difference between the fourth and fifth embodiments is that in the fifth embodiment, the grooves 34 do not taper off towards the base surface 20, but are also present at the outer edge of the base surface 20. Thus, it is bound with a concave-convex line.

1. A positive cutting insert having a chip face, a primary free surface, and a secondary free surface, wherein a cutting edge is formed between the chip face and the primary free surface, characterized in that the secondary free surface is offset relative to the primary free surface towards the interior of the cutting insert and is bounded in a direction parallel to the cutting edge on each side.

2. The cutting insert according to claim 1, characterized in that the secondary free surface extends continuously from a first corner free surface to a second corner free surface.

3. The cutting insert according to claim 2, characterized in that the secondary free surface is designed to be flat.

4. The cutting insert according to claim 2, characterized in that the secondary free surface is designed to be wavy, uneven, or concave as viewed along the associated cutting edge.

5. The cutting insert according to claim 1, characterized in that a plurality of secondary free surfaces are provided along a side of the cutting insert between a first and a second corner free surface.

6. The cutting insert according to claim 5, characterized in that the secondary free surfaces are embodied as grooves between which an extension of the primary free surface extends.

7. The cutting insert according to claim 6, comprising a base surface opposite the chip face, and characterized in that the grooves taper off towards a base side of the cutting insert such that the base surface has a straight outer edge.

8. The cutting according to claim 7, characterized in that the grooves have a constant width.

9. The cutting insert according to claim 1, characterized in that it has a polygonal shape.

10. The cutting insert according to claim 1, comprising a base surface opposite the chip face, and characterized in that it comprises a fastening opening, extending through the base surface and through the chip face.

11. The cutting insert according to claim 1, comprising a base surface opposite the chip face, and characterized in that the cutting insert has a circular shape with a fastening opening extending through a base surface and through the chip face.

12. The cutting insert according to claim 1, characterized in that the chip face is concavely arranged adjacent to the cutting edge.

13. The cutting insert according to claim 1, characterized in that the chip face is negative or flat.
